(19) United States
(12) Patent Application Publication
(10) Pub. No.: US 2005/0287246 A1
(43) Pub. Date: Dec. 29, 2005

(54) Molding machine and locking mechanism for securing tie bars

(75) Inventor: Peter Adrian Looije, Newmarket (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 10/875,027

(22) Filed: Jun. 24, 2004

(51) Int. Cl. B29C 45/66

(52) U.S. Cl. 425/595

(57) ABSTRACT

FIG. 3 illustrates a clamp piston assembly (40) comprising a body portion (44, 46, 48) in which a pocket is provided. The pocket is arranged to receive an insert in the form of a rotatable clamp bushing (48). Sets of blades or wear pads (52, 62) are positioned on both an internal surface (51) of the pocket and the external surface of the clamp bushing (48) and cooperate to form sealable chambers that extend about the circumference of the clamp bushing (48). These chambers are in fluid communication with suitable processor-controlled valves (82, 84) and hydraulic or pneumatic pumps (80) that operative to purge and inject fluid from and into the chambers. Pressurized fluid acting within selected chambers causes rotation of the clamp bushing (54). The insert also contains a row of teeth (58) arranged to selectively engage corresponding teeth (25, 26) in a tie-bar (19, 20). The clamp bushing (48) is hence independently rotatable from its surrounding body (48) that, in use, is mechanically attached to an injection molding machine (10).

### FIELD OF THE INVENTION

This invention relates, in general, to a rotatable clamping (or locking) mechanism that complementarily acts in association with a press (or the like) to develop, ultimately, a clamp force or closure tonnage. The present invention is more particularly, but not exclusively, applicable to the configuration of a clamp piston assembly that is used to securely clamp up, during a molding process and particularly an injection molding process, a column or tie-bar to a platen to produce a closed force path.

### SUMMARY OF THE PRIOR ART

From the exemplary perspective of an injection molding environment, system designers are faced with having to provide reliable and robust clamping systems that operate for extended periods with minimum, if any, maintenance. More particularly, clamp units and clamp assemblies in injection molding systems are designed to run on an almost continuous basis for weeks at a time, if not months at a time. Typically, machine cycle times range from a few seconds to a couple of minutes, with the cycle generally determined by part weight. As such, clamp-up time, i.e. the time required to positively engage the tie bar or column and to apply closure tonnage, sometimes has considerable impact for productivity. Consequently, in certain applications, clamp-up speed is important.

In the injection molding of large articles, such as in the molding of car body parts and the like, the injection molding machines also develop considerable closure tonnage. Indeed, if is not unusual for machines in large tonnage applications to range from 1000 tons of closure pressure to 8000 tons of closure pressure. In view of the forces involved, particularly in large tonnage applications above about 800 tons, the physical scale of components and their construction is both large and strong, respectively. With a typical clamp assembly made from steel, its weight alone can be in the region of about 500 to 1000 kilograms. Such a clamp assembly (including its associated actuation pistons) is fixedly attached to the moving platen (for example).

Even with smaller applications, such as in the production of PET preforms, machines typically must develop something in the range of between 300 and 600 tons of closure pressure.

In terms of achieving clamping of the tie-bar into the platen (i.e. through positive engagement of the tie-bar or column into the clamp piston), each tie-bar or column may include at least one integrally formed annulus of protruding teeth extending from the surface of the cast-steel tie-bar or column. There may be more than one annulus of teeth. Of course, rather than an annulus of teeth, an alternative interlocking mechanism may be realised by rings of notches that are cut into the surface of the tie-bar or column. Also, as will become apparent, to allow relative longitudinal movement of the tie-bar with respect base of the injection unit, each annulus includes at least one channel that is transverse to and disrupts the circumferential continuity of the teeth (or notch). Within the clamp piston, a second set of teeth (or notches) is arranged to be selectively inter-locking with the corresponding teeth in the tie-bar, with the clamp piston therefore dimensioned to closely surround the tie-bar. Again, the circumferential continuity of the rows of teeth (or notches) in the internal surface of the clamp piston are disrupted by at least one channel. Longitudinal alignment of the teeth in the clamp piston with the channel through the teeth (or notch) of the tie-bar (or column) thereby permits axial movement of the tie-bar relative to the clamp piston. Conversely, matched alignment and inter-locking of the respective sets of teeth in both the tie-bar and clamp piston establishes positive engagement and the subsequent ability to develop clamp force through the inter-locking teeth and the application of hydraulic force on a piston surface within the clamp assembly.

In existing systems, such as described in EP-A-0904918, the entire annularly-shaped clamp piston is rotated to cause selective interlocking engagement and disengagement of the teeth. Since the injection molding machine described in this document contains four tie-bars each having an associated clamp piston, a synchronized, mechanically-driven rotation of the entire clamp piston is undertaken. More specifically, exterior surfaces of the clamp pistons are mechanically coupled together through a network of connecting rods. A piston cylinder, within the network of connecting rods, is actuated to cause lateral movement of the rod. This lateral movement is then translated into rotational movement of the clamp piston; the centre of rotation of the clamp piston is concentric with the major axis of each corresponding tie-bar.

In relation to the periodic rotation of the entire clamp piston, the moment of inertia and, fundamentally, the weight of the clamp piston assembly requires equally robust, physically sizeable and relatively costly drive mechanisms. Consequently, considerable energy is expended in rotating the entire clamp piston, which energy consumption has an impact on manufacturing cost overheads. Moreover, from a manufacturing perspective, the cost for producing a unitary clamp piston is not inexpensive, especially when one considers the inherent complexity and highly-toleranced nature of a relatively large component. Also, in the event of any wear or malfunction in the teeth in the clamp piston, the entire clamp piston assembly has to be replaced, which is both expensive and time consuming.

Today's systems often use hydraulic cylinders to rotate the entire clamp piston. With the high pressure rise rates in these cylinders, such prior art systems are susceptible to high amounts of hydraulic shock. Furthermore, there is an associated high level of noise and a high loading of individual components. Moreover, the locking cylinder force in these prior art systems must be relatively high to overcome the clamp seal force and high moment of inertia of the piston.

U.S. Pat. No. 6,200,123 describes a modified clamp piston assembly that includes a rotatable lock bushing mounted within a rotationally fixed, annular clamp piston. An interface between the external surface of the lock bushing and the internal surface of the clamp piston is realised as a screw-thread of inter-engaging teeth. An internal surface of the rotatable lock bushing (also having rows of teeth and corresponding grooves or notches) is arranged to selectively mate with an array of teeth on a outer surface of a push rod, which push rod is used to establish part of the force path for applied closure tonnage (i.e. clamp force). Angular rotation of the lock bushing (between a first position and a second position) therefore either causes engagement or disengagement of the push rod. The lock bushing is mechanically coupled to a turning device (realised by a spline and gear configuration). The turning device is driven by the control of linear actuators that contain racks that operate to engage the gears of the turning device. Whilst this configuration mitigates the requirement to rotate the clamp piston itself, the complexity and reliability of the drive mechanism offsets any potential advantage (particularly fiscal benefit) that is obtained from having a lower power-rated (and hence cheaper) rotational drive mechanism. Moreover, should anything malfunction, then a qualified engineer would expend considerable time in disassembling the combined clamp piston and drive assemblies; and such an extended down-time would be unacceptable in a production environment essentially seeking 24/7 operation.

### SUMMARY OF THE INVENTION

According to the invention there is provided a two-piece clamp piston assembly comprising: a) a body portion having a channel extending through the body portion, the channel including a pocket into which are mounted, in use, a first set of contacts pads; and b) a cylindrical clamp bushing having an external surface into which are mounted, in use, a second set of contact pads; the cylindrical clamp bushing locatable within the pocket whereby the first and second sets of contacts pads cooperate to produce at least two fluid sealable chambers, the cylindrical clamp piston freely rotatable within the pocket such that volumes of the at least two fluid sealable chambers can be varied.

In another aspect of the present invention there is provided a two-piece piston assembly containing a body portion and a clamp bushing insert containing a rotational drive system, the clamp bushing insert independently rotatable with respect to the body portion, the clamp bushing insert containing an engagement mechanism arranged, in use, to positively engage one of a tie bar and a column.

In a third aspect of the present invention there is provided a clamp bushing insert for a two-piece piston assembly, the clamp bushing insert realised by a cylindrical body having: an internal surface containing a plurality of teeth extending at least partially around an inner circumferential surface of the clamp bushing insert and at least one channe extending through the teeth; and an external surface having extending therefrom a plurality of contact pads that define raised areas and valley areas.

In yet another aspect of the present invention there is provided a body portion of a two-piece clamp piston assembly, the body portion having: a shoulder with a first external diameter; a seat having second external diameter relatively smaller than the first external diameter, the shoulder abutting against the seat; a cylindrical channel extending through the body portion, the channel including a pocket with an internal surface into which are mountable a plurality of sealing pads that extend outwardly from the internal surface, the pocket arranged to receive, in use, a freely-rotatable clamp bushing insert.

Another aspect of the present invention provides a platen containing at least one clamping mechanism realised by a two-piece clamp piston assembly comprising: a) a body portion having a channel extending through the body portion, the channel including a pocket into which are mounted, in use, a first set of contacts pads; and b) a cylindrical clamp bushing having an external surface into which are mounted, in use, a second set of contact pads the cylindrical clamp bushing locatable within the pocket whereby the first and second sets of contacts pads cooperate to produce at least two fluid sealable chambers, the cylindrical clamp piston freely rotatable within the pocket such that volumes of the at least two fluid sealable chambers can be varied.

In still yet another aspect of the present invention there is provided a method of effecting clamping of a tie bar or column in an injection molding machine having fixed thereto at least one two-piece clamp piston assembly through which the tie-bar or column extends, the two-piece clamp piston assembly comprising: a body portion having a channel extending through the body portion, the channel dimensioned to surround the tie bar or column and further including an inner surface into which are mounted a first set of contacts pads and a cylindrical clamp bushing insert having an external surface into which are mounted a second set of contact pads, the cylindrical clamp bushing locatable within the body portion whereby the first and second sets of contacts pads cooperate to produce at least two fluid sealable chambers within the two-piece clamp piston assembly; the method comprising: independently and freely of the body portion of the clamp piston assembly, causing independent rotation of the clamp bushing insert through the controlled and selective fluid pressurization of the sealable chambers, whereby volumes of the respective fluid sealable chambers vary with time and the clamp bushing insert selectively achieves positive engagement with the tie bar or column.

Advantageously, the present invention provides a simplified clamping assembly that is actuated by a drive that consumes lower energy. More particularly, the present invention removes the need to spin the entire piston. Additionally, with the reduced mass that is now spun to engage the tie-bar, the present invention can be run faster and on a quieter basis. Furthermore, should there by any breakage or wear in the clamp piston assembly, in situ disassembly and replacement is generally simplified and repair costs potentially minimised to the replacement part, rather than a large assembly. Clearly, with the use of the present invention, the cost associated with providing an appropriately drive to cause positive engagement of the clamp bushing to the tie-bar is reduced, since the power developed by (and energy consumption of) that drive unit is reduced when compared with prior art systems.

The present invention further reduces the amount of hydraulic shock that otherwise occurs with systems that rotate the entire clamp piston assembly. Moreover, the present invention reduces noise associated with high pressure rise rates in the cylinder and further reduces ancillary component loading.

### BRIEF DESCRIPTION OF THE DRAWINGS

Embodiments of the invention will be described, by way of example only, with reference to the drawings, in which:

FIG. 1 shows a prior art injection molding machine that can be adapted to support the concepts of the present invention;

FIG. 2 is a typical structure for a column or tie-bar;

FIG. 3 shows an exploded view of a clamp piston assembly according to a preferred embodiment of the present invention; and

FIG. 4 is a perspective view of the partly assembled clamp piston assembly of FIG. 3.

### DETAILED DESCRIPTION OF THE PREFERRED EMBODIMENT

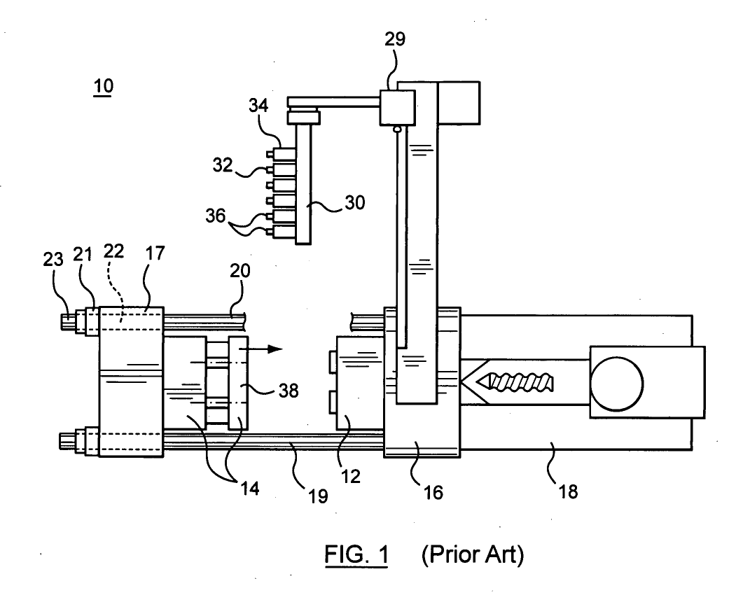

FIG. 1 shows a typical injection molding machine 10 that can be adaptable to support the rotatable clamping (or locking) mechanism of the present invention. During each injection cycle, the molding machine 10 produces a number of plastic parts corresponding to a mold cavity or cavities defined by complementary mold halves 12, 14 located within the machine 10.

The injection-molding machine 10 includes, without specific limitation, molding structure, such as a fixed platen 16 and a movable platen 17 as well as an injection unit 18 for plasticizing and injecting material. In operation, the movable platen 17 is moved relative to the fixed platen 16 by means of stroke cylinders (not shown) or the like. Clamp force is developed in the machine, as will readily be appreciated, through the use of tie bars 19, 20 and a tie-bar clamping mechanism 21. The clamping mechanism 21 is (generally) fixedly attached to the moving platen 17 (typically through the use of bolts), with each clamping mechanism usually extending at least partially into a corresponding bore 22 that extends through the platen at the corners thereof. It is usual that a floating end 23 of the tie-bar 19, 20 is free to move relative to the moving platen, with the other remote end anchored into the stationary platen. Of course, in certain systems, the reverse anchoring methodology may be applied.

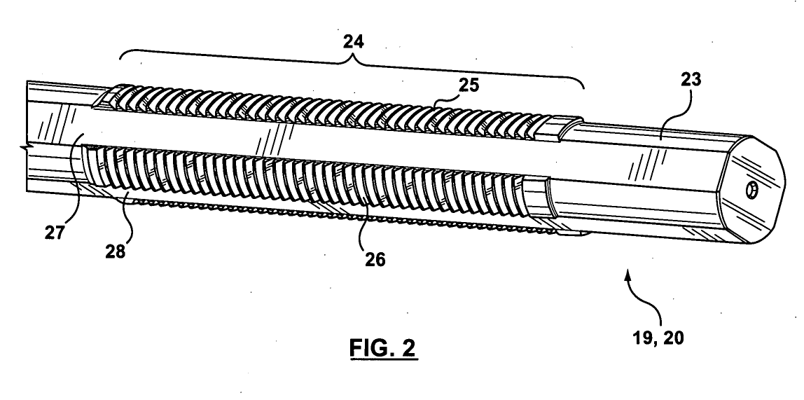

Turning briefly to FIG. 2, a typical tie-bar 19, 20 (or column) is shown. Proximate to the floating end 23 is a section 24 containing one or more annularly-arranged rows of teeth 25, 26. As previously indicated, each row is punctuated by at least one aligned channel 27, 28. The channels 27, 28 provide an ability for complementary (selectively interlocking) teeth to be drawn or pushed through the channel before relative rotation obtains an interlocking engagement.

Referring back FIG. 1, once the tie-bar is positively engaged in its respective clamp piston, mold clamp force (i.e. closure tonnage) can be applied through the use of (typically) a hydraulic system that is usually directly associated with the clamp piston.

The mold halves 12, 14 together constitute a mold generally having one or more mold cavities 22, 24, with the mold halves 12, 14 each located in one of the movable platen 17 and the fixed platen 16. A robot 29 is provided, adjacent the fixed platen 16 and movable platen 17, to carry an end of arm tool (EOAT) 30, such as a vacuum-based take-out plate 32 or the like. In the particular realisation of a take-out plate 32 for preforms, the take-out plate 32 contains a number of cooling tubes 34 at least corresponding in number to the number of preforms (or molded products) 36 produced in each injection cycle.

In use, in a mold open position (as shown in FIG. 1), the robot 29 moves the EOAT 30 into alignment with, typically, a core side of the mold and then waits until molded articles (e.g. preforms 36) are stripped or otherwise ejected from the core(s) into the EOAT 30 by operation of a stripper plate 38, actuator or lift rods or their functional equivalent.

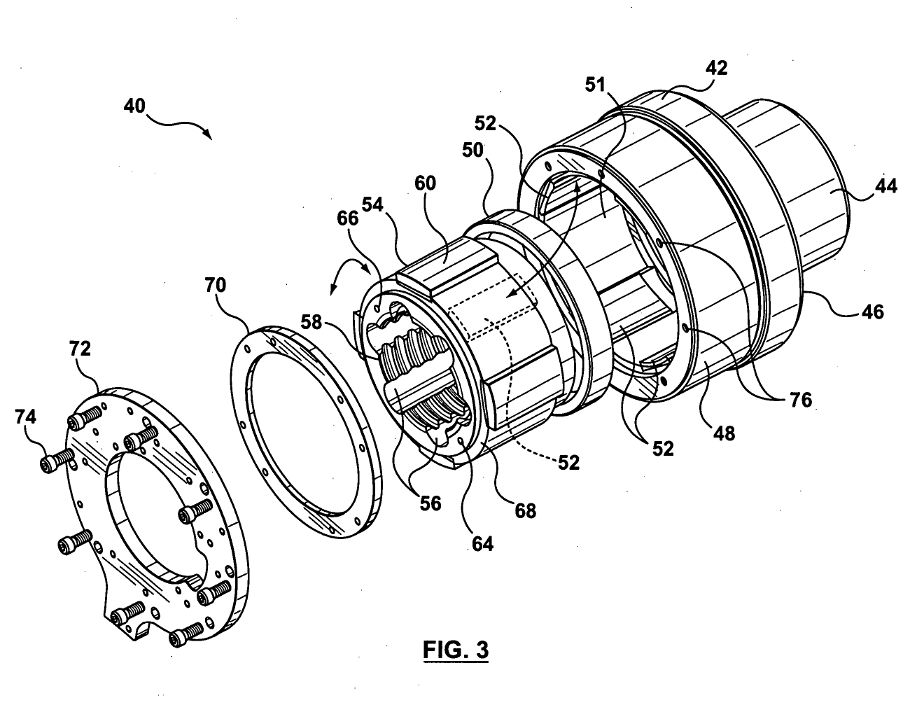

Turning now to a preferred embodiment of the present invention, as shown in FIG. 3, a novel clamp piston assembly 40 is illustrated. The piston assembly 40 includes an annular base 42 that typically includes an annular seat 44 arranged to locate within the bore 22 of the platen 17. Abutting the seat is a shoulder 46 that, in use, rests against the edge of the platen 17, as shown in FIG. 1. The shoulder 46 has a centre concentric with the seat, but obviously has a larger radial diameter. Extending longitudinally from the shoulder 46 is a cylindrical body portion 48 into which a removable sealing ring 50 is internally located. The sealing ring 50 abuts into the shoulder 46 justaposed the annular seat 44. The internal diameters of the of seat 44, body 48 and sealing ring 50 are sufficient to permit a tie-bar or column to pass unhindered therethrough, i.e. there is a physical separation between these respective surfaces and the tie-bar.

Within a pocket (that is defined by an internal circular surface 51 of the body portion 48) are located slots (realised as longitudinal slots in FIG. 3). These slots receive a first set of contact pads 52 that protrude above circular surface 51. The first set of contact pads 52, as will become apparent, act to form a seal with a rotatable clamp bushing 54; this will be described in more detail later. In a preferred embodiment, the first set of contact pads are distributed equally about the internal circumference of the circular surface 51, with there being shown (in the exemplary illustration of FIG. 3) four contact pads that preferably extend lengthways from near (or at) the sealing ring to an open end of the body 48.

The annular base 42 and body 48 of the clamp piston assembly 40 are mechanically coupled to the injection molding machine 10, which mechanical coupling is typically to a platen and which coupling is achieved through replaceable bolts (to allow disassembly) or the like.

The first set of contact pads 52 are preferably replaceable since, over time, frictional wear may cause degradation in the sealing surface and seal integrity. The contact pads may be made from any suitable material, such as an elastomer material or a composite, including carbon fibre or a ceramic. The size and shape of the contact pads can also be varied. As will be understood, my making the contact pads smaller (e.g. narrower), a greater sealing pressure is achieved.

In relation to the rotatable clamp bushing 54, which is now effectively produced as an insert, its internal surface contains lateral guide channels 56 interspersed by at least one row of teeth 58. In the preferred embodiment, multiple rows of teeth are present. The channels 56 and teeth 58 complement the teeth and channels in the tie-bar 19, 20 (of FIG. 2) which are designed to be selectable interlocking under clamp up conditions. On an external surface of the rotatable clamp assembly 56, a second set of contact pads 60 are deposited. The number and location of such second set of pads 60 complements the number and location of the first set of pads 52. Again, the size and shape of each contact pad 60 can also be varied, although it is preferably that they extend across the entire width of the clamp bushing to ensure an optimum seal. The second set of contact pads 60 are preferably replaceable since, over time, frictional wear may cause degradation in the sealing surface and seal integrity. The contact pads may be made from any suitable material, such as an elastomer material or a composite, including carbon fibre or ceramic.

To illustrate the locational (functional) inter-relationship between the first and second sets of pads, an image of one of the first set of pads 52 has been superimposed (in dotted outline) onto the external surface of the clamp bushing 54. As can be seen, the first set of pads 52 therefore fit within the spaces defined the second set of contact pads 60. The external surface of the clamp bushing 54 therefore includes raised areas of “land” (corresponding to the second set of contact pads) and valleys defined by the external area of the clamp bushing between adjacent contact pads 60.

In a preferred embodiment, the contact pads may have a curved profile that corresponds substantially to an inner curvature of the internal surface 51 of the body 48. In passing, it is noted that increased torque can be achieved by providing narrower and thinner contact pads, as will be understood. It is, generally, preferably that the sealing surfaces are, however, as long as possible to mitigate part manufacturing tolerance issues and contact pad wear (arising from frictional forces developed with rotation).

As a result of the structural configuration of the clamp bushing, as attributed particularly to the second set of contact pads, the clamp bushing (upon being inserted into the body 48) produces a plurality of chambers defined by and between the first and second sets of contact pads 52, 60. Since the clamp bushing 54 is rotatable within the body 48 (relative to the first set of contact pads 52), the various chambers can be varied in volume according to the angular position of clamp bushing relative to the fixed first set of contact pads 52. The clamp bushing 54 is further dimensioned such that it will fit within the body 48 and such that there is a seal developed between at least one of: i) the exposed outer surface of the first set of contact pads and the valley area on the clamp bushing; ii) the land area on each of the second set of contact pads 52 and the inner surface 51 of the body 48; and iii) abutting faces of the first and second sets of contact pads 52, 60.

Lift points 64-66 may be provided in the clamp bushing 54 to facilitate removal of the clamp bushing 54 from the body 38.

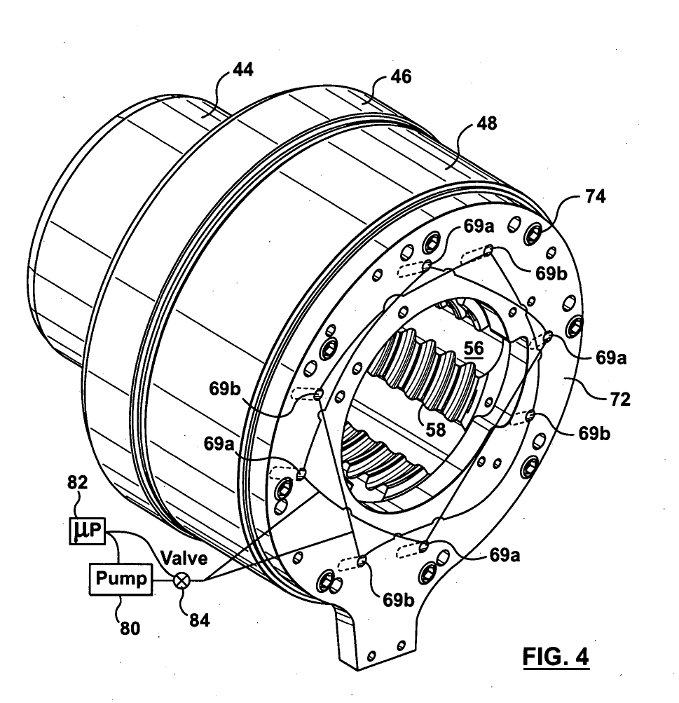

In order to cause rotation of the clamp bushing, at least one valve-controlled conduit for fluid is provided to either side of at least one of the stationary pads 52 so that, when one of the chambers is pressurised, the clamp bushing 48 will rotate. More specifically, by providing a fluid communication path to the chambers defined between the lands and valleys of the clamp bushing, rotational control of the clamp bushing 54 within the body 48 is achieved. In a preferred embodiment, the fluid is air, although alternatives are also contemplated, e.g. hydraulic fluid. By subsequently inducing the expulsion of fluid from the (initially) pressurised chamber, and by introducing fluid onto the other side of the stationary pad 52 to pressurize an adjacent chamber, counter-rotation of the clamp bushing is achieved. In a preferred embodiment, the conduits (reference number 69 in FIG. 4) are formed in the face of the clamp bushing (on a ridge 68 that extends circumferentially about and laterally from a second end of the clamp bushing), although location of the conduits may be at an appropriate point, e.g. through the wall of the body 48.

A locating ring 70 (which also acts as a sealing surface) is mechanically coupled to the body 48, whereby the locating ring retains the clamp bushing 54 within the body 48. The locating ring is further positioned juxtaposed the ridge 68. Finally, an end plate 72 couples the assembly together through bolts 74 (or the like) that engage in correspondingly aligned threaded holes 76 in the body 48.

The assembled clamp piston assembly 40 is then fixed relative to either the moving or stationary platen. Each tie-bar is therefore able to pass through the entire assembly and to be selectably positively engaged by rotation of the clamp bushing 48. In a preferred embodiment, it is preferable that the clamp bushing, when located in the body 48, is under compressive loading, i.e. that the locating ring 70 and/or the shoulder 46 exhibit spring-like characteristics or include dedicated springs, to ensure good face-sealing contact with the clamp bushing 54.

A final assembly of the preferred embodiment is shown in FIG. 4. Concerning operational control of the clamp bushing assembly 40, the preferred embodiment uses an air compressor or pump (or the like) 80 to selectively inject fluid into the chambers defined between the lands and valleys of the clamp bushing. With effective sealing achieved by the first and second sets of contact pads, and selective venting and complementary pressure applied to adjacent chambers (through processor 82 control of the pump 80 and associated valve 84), the fluid pressure (preferably air pressure) provides sufficient force against an edge of the second set of contact pads 62 to cause rotation of the rotatable clamp bushing 54 and hence to achieve engagement or disengagement of the respective teeth on the clamp bushing 54 and tie-bar 19, 20. The conduits 69 are therefore divided into two sets (denoted as 69a and 69b) that are utilised in a complementary, valve-controlled basis. Furthermore, with processor control, fluid can be metered out to damp (i.e. act as a cushion to avoid) shock and vibration arising from clamp bushing rotation.

It will be appreciated that, for operation, it is necessary to produce a minimum of two chambers between the respective sets of contact pads on the exterior surface of the clamp bushing and the interior surface of the pocket (in the body 48).

It is noted that, for the sake of clarity only, the complementary inter-relationship between the two sets of conduits 69a, 69b has been illustrated schematically. Also, from a practical perspective of the preferred embodiment, in the assembled clamp piston assembly, the conduits 69 are preferably located besides (i.e. in relatively close proximity to) the stationary contact pads 52 (or their functional equivalent).

In contrast with prior art systems, a rotation drive system (preferably air-driven) is located between the clamp piston per se and the outer surface of the rotating clamp bushing (or lock ring). With the present invention now providing an integral rotary engagement mechanism in the form of an insert inside the clamp piston, energy requirements to drive engagement and disengagement of the clamp and tie-bar (or column) are therefore reduced to simply overcome the load realised by the weight of the clamp bushing 54 in combination with any drag forces (associated with sealing contacts and residual air pressure in a chamber); this is very much lower than in existing systems.

The piston assembly of FIG. 3 still moves laterally with the piston, although the clamp bushing (provided now as an insert) is independently rotatable.

By way of overview of the in situ operation of the preferred embodiment of the present invention, a pad structure on both the inner surface of the clamp piston and the external surface of the rotatable clamp bushing (or lock ring) cooperate to allow the clamp bushing (bearing teeth and channels) to selectively engage teeth on a tie bar. The clamp bushing is therefore effectively reduced to a replaceable insert within a clamp piston body. Through the control of pressure into chambers formed by seals realized between the various pads (or their functional equivalent), relative rotational and sliding movement is achieved between the body of the clamp piston and the clamp piston bushing. The pads on the bushing therefore essentially act to provide piston surfaces.

It will, of course, be appreciated that the above description has been given by way of example only and that modifications and variations will be readily apparent to the skilled exponent without departing from the scope of the appended claims. For example, whilst the preferred embodiment has been described in the context of a tie-bar in a 2-platen injection molding environment, the present invention can equally easily find application in the securing of a central column (in a 3-platen design) or in other equivalent press-like systems in which a clamping cycle is succeeded by some form of relative movement between the piston and tie-bar (or the like). Equally, the present invention can find application in specific forms of press-based technology, including (but not limited to) thixomolding and blow molding, over a variety of closure pressures from tens to thousands of metric tons. Additionally, whilst the preferred embodiment has been described in the context of two sets of contacts pads, it is also possible for the pads to be realised by a fixed set of “lands” and a complementary set of contacts pads or blades (or their functional equivalent) that are arranged to engage these lands to produce the sealing surface. Of course, the optimum solution is to provide the largest sealing surface to define the various discrete fluid-tight chambers between the external surface of the clamp bushing and the internal surface of the annular base. Furthermore, whilst the preferred embodiment has been described in relation to a pneumatically-driven system, it is conceivable that rotation of the clamp bushing 54 could be influenced and controlled by a hydraulic system.

In the context of the present invention, therefore, the term “contact pad” or “pad” should be considered to include and embrace any functional variant (e.g. a blade or land) that acts to allow the production of a sealed chamber (whose volume can be varied by relative rotation) between the internal surface of the body 48 and the clamp bushing 54.

1. A two-piece clamp piston assembly comprising:
a) a body portion having a channel extending through the body portion, the channel including a pocket into which are mounted, in use, a first set of contacts pads; and
b) a cylindrical clamp bushing having an external surface into which are mounted, in use, a second set of contact pads;
the cylindrical clamp bushing locatable within the pocket whereby the first and second sets of contacts pads cooperate to produce at least two fluid sealable chambers, the cylindrical clamp piston freely rotatable within the pocket such that volumes of the at least two fluid sealable chambers can be varied.

2. The two-piece clamp piston assembly according to claim 1, wherein at least one of the first and second sets of contact pads are removable.

3. The two-piece clamp piston assembly according to claim 1, wherein the second set of contact pads (60) define at least two valley regions and at least two raised land regions on the cylindrical clamp bushing, and wherein the pocket has an internal surface and the first and second sets of contact pads develop a sealing surface between at least one of:
i) an exposed outer surface of the first set of contact pads and the valley regions on the clamp bushing;
ii) the land regions of the second set of contact pads 52 and the internal surface of the body portion; and
iii) abutting faces of the first and second sets of contact pads.

4. The two-piece clamp piston assembly according to claim 1, further including a locating ring coupled to the body portion, whereby the locating ring retains the cylindrical clamp bushing within the body portion.

5. The two-piece clamp piston assembly according to claim 4, wherein the locating ring further acts as a sealing surface with respect to at least one of the first and second sets of contact pads.

6. The two-piece clamp piston assembly according to claim 1, further including a plurality of fluid conduits in fluid communication with each of the chambers, the fluid conduits located on either side of each of the first set of contact pads.

7. The two-piece clamp piston assembly according to claim 6, further including at least one valve for controlling fluid flow through the fluid conduits.

8. The two-piece clamp piston assembly according to claim 1, further including a sealing ring (50) located within the pocket but constrained within the pocket by the cylindrical clamp bushing.

9. The two-piece clamp piston assembly according to claim 1, wherein the body portion further includes a seat that abuts against a shoulder, the seat arranged to locate, in use, into a bore of a platen.

10. The two-piece clamp piston assembly according to claim 1, wherein the cylindrical clamp bushing has an internal surface having a circumference, the internal surface including:
i) at least one annular row of teeth extending at least partially around the circumference; and
ii) at least one channel extending through the annular row of teeth.

11. The two-piece clamp piston assembly according to claim 1, wherein the first and second sets of contact pads are made from one of: an elastomeric material; carbon fibre; and a ceramic.

12. A two-piece piston assembly containing a body portion and a clamp bushing insert containing a rotational drive system, the clamp bushing insert independently rotatable with respect to the body portion, the clamp bushing insert containing an engagement mechanism arranged, in use, to positively engage one of a tie bar and a column.

13. The two-piece piston assembly according to claim 12, wherein the body portion includes a pocket in which the clamp bushing insert is located and the rotational drive system is located between an inner surface of the pocket and an outer surface of the clamp bushing insert.

14. The two-piece piston assembly according to claim 13, wherein the rotational drive system includes a plurality of outwardly extending contact pads coupled to the surface of the clamp bushing insert.

15. The two-piece piston assembly according to claim 12, wherein the engagement mechanism is realised by:
a plurality of teeth extending at least partially around an inner circumferential surface of the clamp bushing insert; and
ii) at least one channel extending through the teeth.

16. A clamp bushing insert for a two-piece piston assembly, the clamp bushing insert realised by a cylindrical body having:
an internal surface containing a plurality of teeth extending at least partially around an inner circumferential surface of the clamp bushing insert and at least one channel extending through the teeth; and
an external surface having extending therefrom a plurality of contact pads that define raised areas and valley areas.

17. The clamp bushing insert of claim 16, wherein the plurality of contacts pads are removable.

18. A body portion of a two-piece clamp piston assembly, the body portion having:
a shoulder with a first external diameter;
a seat having second external diameter relatively smaller than the first external diameter, the shoulder abutting against the seat;
a cylindrical channel extending through the body portion, the channel including a pocket with an internal surface into which are mountable a plurality of sealing pads that extend outwardly from the internal surface, the pocket arranged to receive, in use, a freely-rotatable clamp bushing insert.

19. A platen containing at least one clamping mechanism realised by a two-piece clamp piston assembly comprising:
a) a body portion having a channel extending through the body portion, the channel including a pocket into which are mounted, in use, a first set of contacts pads; and
b) a cylindrical clamp bushing having an external surface into which are mounted, in use, a second set of contact pads), the cylindrical clamp bushing locatable within the pocket whereby the first and second sets of contacts pads cooperate to produce at least two fluid sealable chambers, the cylindrical clamp piston freely rotatable within the pocket such that volumes of the at least two fluid sealable chambers can be varied.

20. A method of effecting clamping of a tie bar or column in an injection molding machine having fixed thereto at least one two-piece clamp piston assembly through which the tie-bar or column extends, the two-piece clamp piston assembly comprising:
a body portion having a channel extending through the body portion, the channel dimensioned to surround the tie bar or column and further including an inner surface into which are mounted a first set of contacts pads; and
a cylindrical clamp bushing insert having an external surface into which are mounted a second set of contact pads, the cylindrical clamp bushing locatable within the body portion whereby the first and second sets of contacts pads cooperate to produce at least two fluid sealable chambers within the two-piece clamp piston assembly;
the method comprising:
independently and freely of the body portion of the clamp piston assembly, causing independent rotation of the clamp bushing insert through the controlled and selective fluid pressurization of the sealable chambers, whereby volumes of the respective fluid sealable chambers vary with time and the clamp bushing insert selectively achieves positive engagement with the tie bar or column.

21. The method of claim 20, wherein fluid pressurization of the sealable chambers is through the use of a pressurized gas.

22. The method of claim 20 further comprising:
controlling independent rotation of the clamp bushing insert through selective operation of valves located within a fluid path to and from the sealable chambers.

23. The method of claim 22, further comprising metering of fluid to damp rotational movement of the clamp bushing insert.
